(19) United States
(12) Patent Application Publication
(10) Pub. No.: US 2023/0068779 A1
(43) Pub. Date: Mar. 2, 2023

(54) Method for Evicting Data from Memory

(71) Applicant: Technische Universitat Munchen, Munchen (DE)

(72) Inventors: Nael Fasfous, Munchen (DE); Akshay Srivatsa, Munchen (DE); Nguyen Anh Vu Doan, Munchen (DE); Thomas Wild, Munchen (DE); Andreas Herkersdorf, Inning (DE)

(21) Appl. No.: 17/797,869

(22) PCT Filed: Feb. 26, 2021
(86) PCT No.: PCT/EP2021/054888

§ 371 Date: Aug. 5, 2022

(30) Foreign Application Priority Data
Mar. 3, 2020 (EP) 20160816.3

(51) Int. Cl. G06F 12/0891

(52) U.S. Cl. CPC G06F 12/0891; G06F 2212/1024

(57) ABSTRACT

Provided is a resource manager. The resource manager may be a memory manager which is configured to determine a plurality of eviction rankings, wherein each of the plurality of eviction rankings assigns a position within the eviction ranking to each of a plurality of eviction candidates based on at least one eviction criterion. The memory manager may then select one of said eviction candidates by applying a voting algorithm to the plurality of eviction rankings and cause the selected eviction candidate to be evicted.

### FIELD

The present disclosure relates to computer resource management. In particular, the present disclosure relates to memory management and involves a decision-making process which can be used in a procedure for evicting data from memory, wherein the decision-making process allows selecting an eviction candidate based on a plurality of eviction criteria.

### BACKGROUND

If a physical memory cannot hold all data that may be accessed by a device to which the memory is assigned, it may be feasible to strive at populating the memory with the most valuable data. If the memory is used as a cache, the most valuable data may be the data that introduces the highest overall latency or, more generally, requires the most resources if the data is to be retrieved from other sources. An eviction candidate may thus be selected based on one or more eviction criteria, which makes (presumably) room for more valuable data. Moreover, a similar kind of decision-making may also be needed in other scenarios in which a resource of a plurality of resources is to be assigned to a particular use.

With regard to managing objects stored in a cache, EP 1 503 303 A2 provides a mechanism for determining which objects to evict based on a weight that is calculated for each object stored in the cache, wherein the weight is determined by at least two factors, including file size, file type, primary user, last access time, and the like, and by the relative importance of each of the factors.

### SUMMARY

The present disclosure provides a resource manager and a method of managing a resource.

The resource manager is configured to determine a plurality of rankings, wherein each of the plurality of rankings ranks (e.g., assigns a position within the ranking to each of) a plurality of resources based on at least one criterion, to select one of said resources by applying a voting algorithm to the plurality of rankings and to cause the resource to be reassigned.

In this regard, the feature that “each of the plurality of rankings assigns a position within the ranking to each of a plurality of resources”, as used throughout the description, has the effect that each of the plurality of resources has several positions assigned to it, wherein each of said positions signifies how favorable it would be to reassign the resource in view of the at least one criterion on which the corresponding ranking is based.

The resource manager may be a memory manager.

The memory manager may be configured to determine a plurality of eviction rankings, wherein each of the plurality of eviction rankings ranks (e.g., assigns a position within the eviction ranking to each of) a plurality of eviction candidates based on at least one eviction criterion, to select one of said eviction candidates by applying a voting algorithm to the plurality of eviction rankings and to cause the selected eviction candidate to be evicted.

In this regard, the term “memory manager”, as used throughout the description and the claims, particularly refers to an integrated circuit. The memory manager and the memory may be parts of the same integrated circuit or of different integrated circuits which are interconnected (e.g., by a bus). Moreover, the memory manager may serve a single memory or multiple memories. For example, each memory may indicate its eviction candidates to the memory manager, and the memory manager may return (for each memory) a selected one of said eviction candidates. Furthermore, (if the memory manager serves different memories) the eviction criteria to be used to determine the eviction rankings may be different for different memories. In addition, the eviction criteria may be adapted at run time. For example, the eviction criteria may be adapted based on an observe-learn-adapt scheme or statically, if the memory manager favors a particular data configuration (as witnessed by a set of eviction candidates that is spared from eviction over a substantial number of selection cycles).

Moreover, the term “eviction candidate”, as used throughout the description and the claims, particularly refers to a memory block. A memory block may span (consecutive) bit positions within the memory and be referenceable by an index (or pointer). In this regard, the formulation “cause the selected eviction candidate to be evicted”, as used throughout the description and the claims, particularly refers to replacing the data stored at said bit positions. The replacement data may be data which was recently requested but not contained in the memory, or the replacement data may be data which was previously neither available from the memory nor from other memories.

Furthermore, the term “eviction ranking”, as used throughout the description and the claims, particularly refers to an assignment of positions to the eviction candidates, the positions establishing an order between the eviction candidates which reflects how well the eviction candidates meet the one or more eviction criteria on which the eviction ranking is based. In this regard, it is noted that throughout the specification and the claims, a top position in the eviction ranking signifies that the eviction candidate to which the top position is assigned is favored for eviction in accordance with the one or more eviction criteria on which the eviction ranking is based.

Further, the term “voting algorithm”, as used throughout the description and the claims, particularly refers to an algorithm which determines the most favored eviction candidates across multiple eviction rankings by aggregating measures of favorability derived from the multiple eviction rankings. For example, if all available eviction rankings have the top position assigned to the same eviction candidate, said eviction candidate will be selected if applying the voting algorithm to the eviction rankings. Analogously, if all available eviction rankings have the bottom position assigned to the same eviction candidate, said eviction candidate will not be selected for eviction.

The memory manager may be further configured to determine the plurality of eviction rankings in parallel.

In this regard, the formulation “to determine . . . in parallel”, as used throughout the description and the claims, particularly refers to a temporal overlap in the processing of signals/data through which different eviction rankings are established. For example, a determination of a first eviction ranking and a second eviction may be started (and performed) at the same time.

The memory manager may be further configured to reapply the voting algorithm to a subset of the plurality of eviction rankings if a tie occurs between candidates that are most favored for eviction by the voting algorithm, or the memory manager may be further configured to apply another voting algorithm to the plurality of eviction rankings if a tie occurs between candidates that are most favored for eviction by the previously applied voting algorithm.

For example, the voting algorithm may establish an eviction ranking and a highest position of the eviction ranking may be assigned to two (or more) eviction candidates which thus end up in a tie. If a tie occurs, the memory manager may reapply the voting algorithm to a subset of the plurality of eviction rankings (consisting of fewer eviction rankings than previously considered), wherein the subset may also comprise only one eviction ranking, apply another voting algorithm to the plurality of eviction rankings, or select one of the eviction candidates (at random). The memory manager may also switch between different tie resolution strategies. For example, the memory manager may apply the voting algorithm to a subset of the plurality of eviction rankings and then apply another voting algorithm, if the tie persists. Likewise, the memory manager may apply another voting algorithm to the plurality of eviction rankings and then apply the other voting algorithm to a subset of the plurality of eviction rankings, if the tie persists.

The memory manager may be further configured to randomly select one of the eviction candidates between which a tie has occurred, if reapplying the voting algorithm or applying the other voting algorithm does not favor one of the candidates previously most favored for eviction by the voting algorithm.

The method comprises determining a first ranking which ranks a plurality of resources based on at least one first criterion, determining a second ranking which ranks the plurality of resources based on at least one second criterion, determining a first resource for reassignment based on the first eviction ranking and the second eviction ranking, and reassigning the first resource.

The method may be applied to managing a memory.

If applied to managing a memory, the method may comprise determining a first eviction ranking which ranks a plurality of eviction candidates (e.g., memory blocks) based on at least one first eviction criterion, determining a second eviction ranking which ranks the plurality of eviction candidates based on at least one second eviction criterion, determining a first eviction candidate (for eviction) based on the first eviction ranking and the second eviction ranking (e.g., by applying a voting algorithm to the first and second eviction rankings), and evicting the first eviction candidate.

For example, evicting the first eviction candidate may involve replacing first data stored in the first eviction candidate (memory block) with second data.

Determining the first memory block for eviction based on the first eviction ranking and the second eviction ranking may involve applying a voting algorithm to the first eviction ranking and the second eviction ranking.

The first and second eviction rankings may assign, to each block of the memory, a position in the first eviction ranking and the second eviction ranking, respectively.

A memory block to which a lowest position in the first eviction ranking and/or a lowest position in the second eviction ranking is assigned, may be excluded from being determined as the first memory block.

Hence, memory blocks which are most favored by one of the eviction rankings can be preserved.

Determining the first memory block for eviction based on the first eviction ranking and the second eviction ranking may comprise assigning a third value to the first memory block, wherein the third value is an output of a function which takes a first value assigned to a first position of the first memory block in the first eviction ranking and a second value assigned to a second position of the first memory block in the second eviction ranking as inputs.

For example, the third value may be a weighted sum across all values assigned to the positions of the eviction candidate in the eviction rankings.

The third value may be used to establish a voting result and the first memory block may be a memory block to which is assigned a highest position in the voting result.

Determining the first memory block for eviction based on the first eviction ranking and the second eviction ranking may further comprise assigning a sixth value to a second memory block, wherein the sixth value is an output of the function which takes a fourth value assigned to a fourth position of the second memory block in the first eviction ranking and a fifth value assigned to a fifth position of the second memory block in the second eviction ranking as inputs, wherein, if the sixth value equals the third value, one of the first and second eviction rankings is disregarded for determining the first memory block for eviction.

The third value may be a linear combination of the first value and the second value.

Notably, the method is not limited to a particular voting algorithm. Rather, a wide range of voting algorithms may be including, but not limited to, the Borda count, the Condorcet method, plurality voting, the two-round system, the Schulze method, etc.

The voting result may assign a position to each of the plurality of eviction candidates, or only to some of the plurality of eviction candidates.

The method may further comprise monitoring the eviction decisions for favoritism and adapting the function if favoritism is detected.

The method may further comprise determining a third eviction ranking which ranks the plurality of memory blocks based on at least one third eviction criterion, determining a preliminary voting result based on the first eviction ranking, the second eviction ranking and the third eviction ranking, and detecting a tie regarding the first memory block and a second memory block, based on the preliminary voting result.

In response to detecting the tie, a final voting result may be determined based on the first eviction ranking and the second eviction ranking.

The method may further comprise determining a fourth eviction ranking which ranks the plurality of memory blocks based on the at least one first eviction criterion, determining a fifth eviction ranking which ranks the plurality of memory blocks based on the at least one second eviction criterion, selecting a third memory block for eviction based on the fourth eviction ranking and the fifth eviction ranking, and replacing third data stored in the third memory block with fourth data.

That is, the eviction criteria/policies may be kept static for multiple consecutive (or even all) evictions.

The memory may be a cache and the method may further comprise detecting a cache miss in regard to the second data and determining that the cache is full.

It will be appreciated that the features and attendant advantages of the disclosed method may be realized by the disclosed manager and vice versa. Moreover, it is noted that the ordinal numbers “first”, “second”, “third”, etc. as used throughout the description and the claims shall not be interpreted as establishing an order between the entities to which they refer, unless explicitly stated otherwise, as they are generally used to identify a particular entity of a plurality of entities (e.g., “first memory block”, “second memory block”, “first eviction ranking”, “second eviction ranking”, “first position”, “second position”).

### BRIEF DESCRIPTION OF DRAWINGS

The foregoing aspects and many of the attendant advantages will become more readily appreciated as the same becomes better understood by reference to the following description of embodiments, when taken in conjunction with the accompanying drawings, wherein like reference numerals refer to like parts throughout the various views, unless otherwise specified. In this regard, it is noted that although the described embodiments relate to memory management, other resources than memories (e.g., processors, processor cores, bandwidth, etc.) are also contemplated.

FIG. 1 illustrates a process of determining eviction rankings and determining a first memory block for eviction based on the eviction rankings;

FIG. 2 illustrates resolving ties in the process of FIG. 1;

FIG. 3 shows a memory and a memory manager;

FIG. 4 shows a flow chart of the process;

FIG. 5 to FIG. 7 show further examples of procedures for resolving a tie; and

FIG. 8a and FIG. 8b illustrate detecting favoritism.

Notably, the drawings are not drawn to scale and unless otherwise indicated, they are merely intended to conceptually illustrate the structures and procedures described herein.

### DESCRIPTION OF EMBODIMENTS

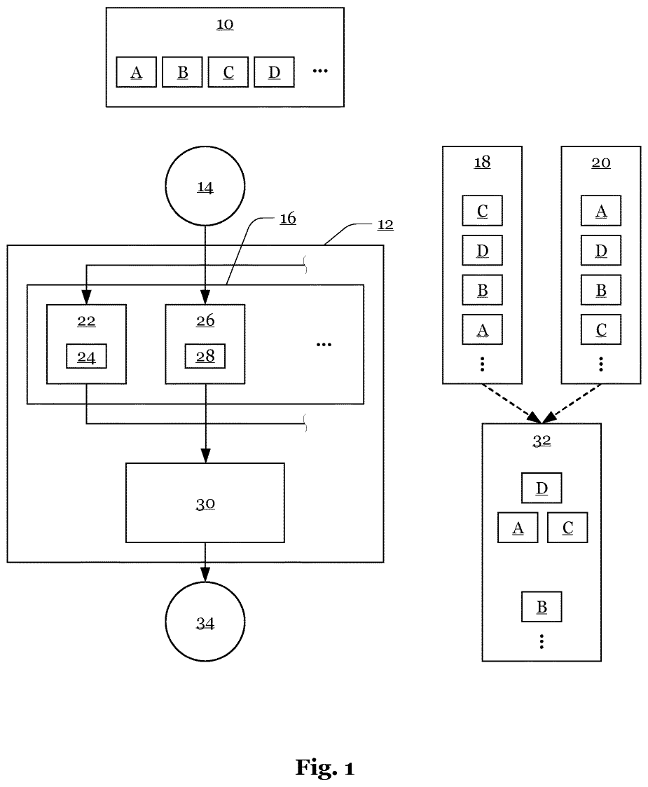

FIG. 1 shows memory 10 which comprises memory blocks A, B, C and D. Memory 10 may contain more or less memory blocks than memory blocks A, B, C and D shown in FIG. 1, but the remainder of this description is written as if memory 10 contained only memory blocks A, B, C and D, i.e., as if memory 10 was divided into memory blocks A, B, C and D. When all blocks A, B, C and D of memory 10 contain valid data, storing data that is not yet contained in (or by the nature of its content affiliated with) one of memory blocks A, B, C and D, is preceded by execution of a memory management process that decides which one of memory blocks A, B, C or D is to be evicted.

Execution of the memory management process by memory manager 12 is triggered by decision request 14. Decision request 14 causes ranking unit 16 of memory manager 12 to generate multiple eviction rankings 18 and 20. Eviction ranking 18 is generated by ranking module 22. Ranking module 22 comprises (or has access to) one or more eviction criteria 24. The one or more eviction criteria 24 and optionally one or more rules relating to the one or more eviction criteria 24 define a specific eviction policy.

Eviction ranking 20 is generated by ranking module 26 which can be operated in parallel with ranking module 22. Ranking module 26 also comprises (or operates in accordance with) one or more eviction criteria 28 and optionally one or more rules relating to the one or more eviction criteria 28. The one or more eviction criteria 28 and optionally one or more rules define a specific eviction policy which differs from the eviction policy followed by ranking module 22. Ranking modules 22 and 26 thus operate on (the same) set of eviction candidates (i.e., memory blocks A, B, C and D of memory 10) but differ in regard to the eviction policies they follow. As indicated in FIG. 1, ranking unit 16 may contain further ranking modules (not shown) each of which is unique in view of the eviction policy that it follows.

Each of eviction rankings 18 and 20 assigns a position to each of memory blocks A, B, C and D. The positions assigned to memory blocks A, B, C and D reflect which one of memory blocks A, B, C and D is to be evicted first, which one of memory blocks A, B, C and D is to be evicted second, etc. In other words, eviction rankings 18 and 20 are reflective of a preference with which each of memory blocks A, B, C and D is to be evicted or maintained under the applied eviction policies. Hence, although eviction rankings 18 and 20 may (depending on the applied eviction policies) both assign the same positions to memory blocks A, B, C and D, eviction rankings 18 and 20 can generally be expected to order the same eviction candidates in different ways.

For example, each of eviction rankings 18 and 20 may be based on one eviction policy selected from the group consisting of Least Recently Used (LRU) and Least Frequently Used (LFU). If memory 10 is employed in a multi-core environment that has multiple memories (caches) that possibly contain (in part) the same data and a sparse directory, each of eviction rankings 18 and 20 may be based on one eviction policy selected from the group consisting of Least Recently Used (LRU), Least Frequently Used (LFU), Least Number of Sharers (LNS) and Shortest Distance First (SDF). However, the present disclosure is not limited to said eviction policies.

In the present example, eviction ranking 18 would, if being the only one of eviction rankings 18 and 20 that is relied on, suggest evicting memory block C. Eviction ranking 20 would, if being the only one of eviction rankings 18 and 20 that is relied on, suggest evicting memory block A. To determine which one of memory blocks A, B, C and D is to be evicted, the memory manager 12 contains a voting unit 30 which processes the eviction rankings 18 and 20. Voting unit 30 translates positions assigned to a memory block to numerical values Vᵢ (with i identifying the eviction policy) and aggregates the numerical values (for example, by summing them up: Σᵢ₌₀ⁿVᵢ, with n being the number of eviction policies that are available or taken into account). For instance, voting unit 30 may assign:
a “1” and a “4” to memory block A, as memory block A is at the lowest position in eviction ranking 18 and at the highest position in eviction ranking 20, and add both numerical values which results in a “5” for memory block A.
two times a “2” to memory block B, as memory block B is immediately above the lowest position in eviction ranking 18 and immediately above the lowest position in eviction ranking 20, and add both numerical values which results in a “4” for memory block B.
a “4” and a “1” to memory block C, as memory block C is at the highest position in eviction ranking 18 and at the lowest position in eviction ranking 20, and add both numerical values which results in a “5” for memory block C.
two times a “3” to memory block D, as memory block D is immediately below the highest position in eviction ranking 18 and immediately below the highest position in eviction ranking 20, and add both numerical values which results in a “6” for memory block D.

By reordering memory blocks A, B, C and D from highest aggregated value to lowest aggregated value, a voting result 32 (which may be a full eviction ranking as shown in FIG. 1, but may also be a partial eviction ranking or only memory block D) may be established and memory block D (to which the highest position in the voting result 32 is assigned) may be returned by memory manager 12 in decision response 34 which causes memory block D to be evicted. Notably, the above described voting algorithm which applies a linear function to numerical values assigned to the positions is but one example and shall not be construed as limiting, because the described concept lends itself not only to various adaptions of the function but also to fundamentally different voting algorithms.

For example, the voting algorithm may be adapted by assigning weights a, to eviction rankings 18 and 20, and the numerical values assigned to the positions may be multiplied with the weights before being summed up: Σᵢ₌₀ⁿαᵢVᵢ. Furthermore, instead of or in addition to multiplying the numerical values with weights, one or more of the numerical values Vᵢ may be replaced with vᵢ^{j} with j≠1: Σᵢ₌₀ⁿVᵢ^{j} or Σᵢ₌₀ⁿαᵢVᵢ^{j}. Moreover, instead of considering all positions, only N positions (for example, the N highest positions) may be taken into account (with N being an integer that is smaller than the number of eviction candidates). Furthermore, certain eviction candidates may be flagged as “not-to-evict” because they achieved a relatively low position in one or more of eviction rankings 18 and 20 (such as memory block A and memory block C in the depicted example).

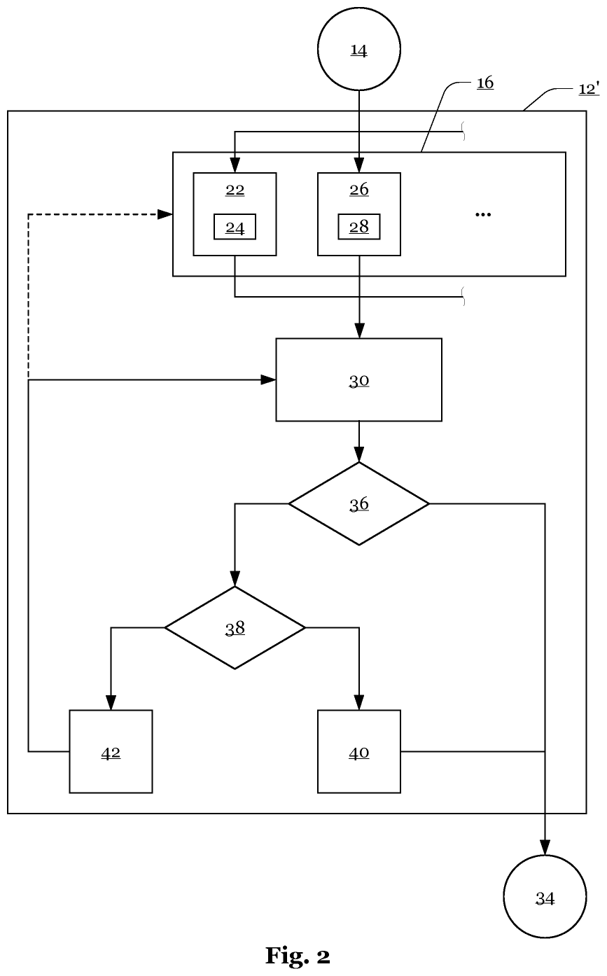

As illustrated in FIG. 1, applying a voting algorithm to eviction rankings 18 and 20 may result in a tie regarding two or more of memory blocks A, B, C and D. If there is no tie regarding the top position, as in the example depicted in FIG. 1, tie resolution may not be required. But if a tie must be resolved, tie resolution may be performed as will be explained with reference to FIG. 2. There, if a need for tie resolution is detected at decision block 36, it is determined at decision block 38 whether a policy agnostic or a policy dependent tie resolution is to be performed.

If it is decided at decision block 38 that a policy agnostic tie resolution is to be performed, action block 40 is invoked which randomly selects one of (or orders) the eviction candidates involved in the tie or settles the tie based on memory transaction states or memory types. Memory transaction states (which may be related to a coherence protocol) may indicate whether a memory block can be readily evicted (which is the case if, for example, the memory block is in a stable state) or whether a waiting time is required before the memory block can be evicted (which is the case, for example, if the memory block is in a transition state). Ties may also be resolved based on memory types (SRAM, DRAM, etc.) as they may have different write-back times. Both memory transaction states and memory types may not be limited to tie-resolution and may (also) be used as an eviction criterion.

If it is decided at decision block 38 that a policy dependent tie resolution is to be performed, action block 42 is invoked which causes voting unit 30 to disregard one of eviction rankings 18 and 20. Another option would be to cause ranking unit 16 to provide additional (or modified) eviction rankings (not shown). For instance, ranking unit 16 may comprise M ranking modules (including ranking modules 22 and 26), each of which applies a different eviction policy to the same set of eviction candidates. If only a subset of the available ranking units is active, additional ranking modules may be activated at request. Likewise, ranking modules may be temporarily inactivated at request. In other words, ranking unit 16 may be provided with a plurality of ranking modules (including ranking modules 22 and 26) which can be activated and deactivated at run time, meaning that a deactivated ranking module does either not provide an eviction ranking or, that the eviction ranking of a deactivated ranking module is disregarded by the voting unit 30. Moreover, ranking modules 22 and 26 may allow for the modification of the underlying eviction polices at run time.

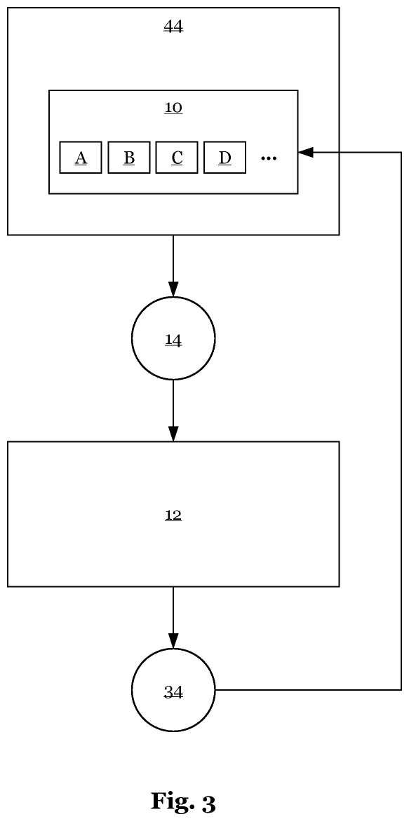

As schematically illustrated in FIG. 3, memory manager 12 may be connected to system 44 which comprises memory 10. System 44 may further comprise one or more processor cores (no shown) and one or more further memories. If an entity within system 44 (such as a processor core) to which memory 10 is assigned requests data that is not stored in memory 10, it may be decided to add said data to memory 10 to avoid future memory misses. If memory 10 is full, decision request 14 may be made. In case that one of memory managers 12 or 12′ receives decision requests 14 for different memories, all information required by memory manager 12 or 12′ may be provided by system 44 through decision request 14.

For example, decision request 14 may comprise a list of eviction candidates, the eviction policies to be used and the parameters of each eviction candidate that are to be evaluated in accordance with the eviction policies. In case that memory manager 12 or 12′ receives decision requests 14 only for memory 10, the information required by memory manager 12 or 12′ may already be available in memory manager 12 or 12′ or received (in total or part) through decision request 14. If system 44 comprises a plurality of instances of memory 10, each one may be provided with a dedicated memory manager or multiple instances may share a single memory manager.

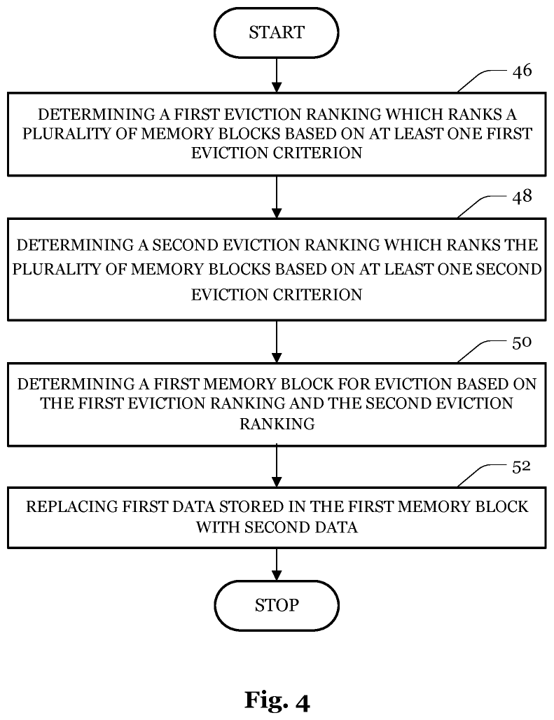

FIG. 4 shows a flow chart of some basic steps performed by memory manager 12. At step 46, memory manager 12 determines eviction ranking 18 which ranks the plurality of memory blocks A, B, C and D based on eviction criterion 24. At step 48, memory manager 12 determines eviction ranking 20 which ranks the plurality of memory blocks A, B, C and D based on eviction criterion 28. Notably, steps 46 and 48 may be performed concurrently. At step 50, memory manager 12 determines memory block D for eviction based on eviction ranking 18 and eviction ranking 20. At step 52, data stored in memory block D is replaced.

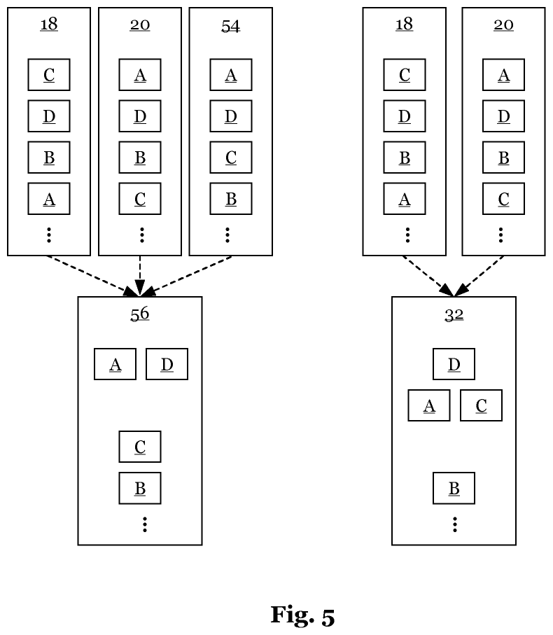

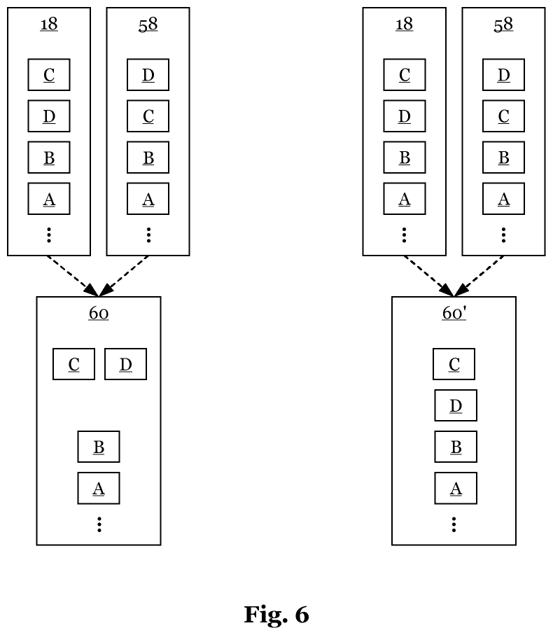

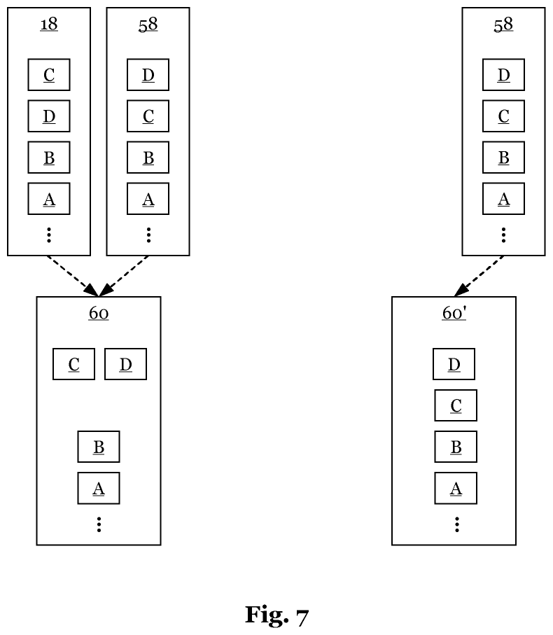

FIG. 5 shows an example where a voting on eviction rankings 18, 20 and 54 results in a tie regarding the top position in voting result 56. As shown in FIG. 5, this tie may be resolved by disregarding eviction ranking 54. FIG. 6 shows another example where a voting on eviction rankings 18 and 58 results in a tie regarding the top position in voting result 60. As shown in FIG. 6, this tie may be resolved by randomly ordering memory blocks C and D involved in the tie. FIG. 7 shows an alternative tie resolution where eviction ranking 18 is disregarded to resolve the tie, leading to result 60′.

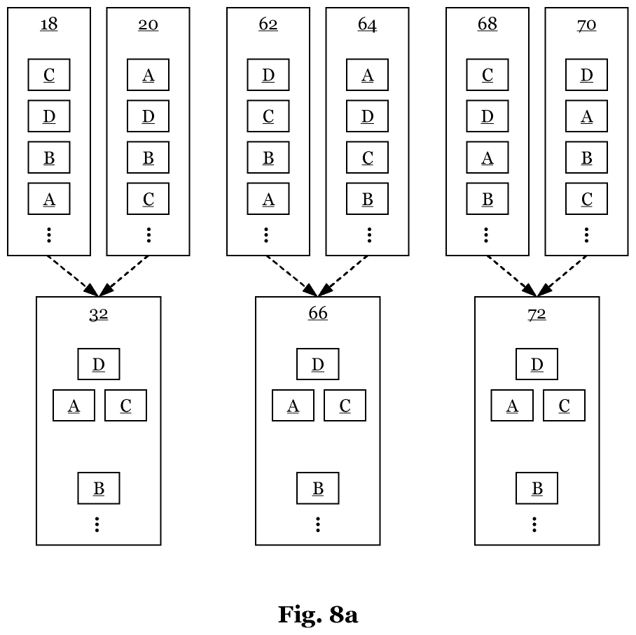

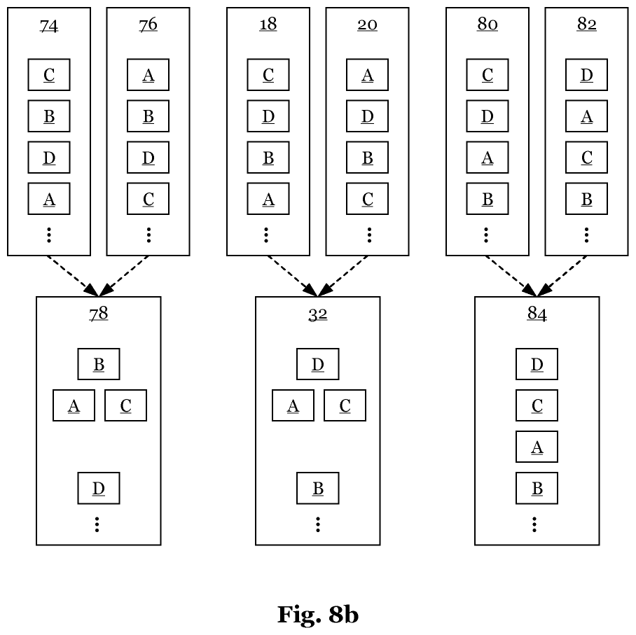

FIG. 8a and FIG. 8b illustrate a series of ranking and voting steps performed on memory blocks A, B, C and D which exhibit favoritism which reveals itself in that a substantially static series of voting results 32, 66, 72, 78, 32 and 84 is determined from eviction rankings 18, 20, 62, 64, 68, 70, 74, 76, 18, 20, 80 and 82. In response, an additional ranking module may be activated, one of ranking modules 22, 26 may be deactivated, or the voting algorithm may be adapted as described above.

### REFERENCE SIGNS LIST

10 memory
12 memory manager
12′ memory manager
14 decision request
16 ranking unit
18 eviction ranking
20 eviction ranking
22 ranking module
24 eviction criterion
26 ranking module
28 eviction criterion
30 voting unit
32 voting result
34 decision response
36 decision block (“tie resolution?”)
38 decision block (“policy agnostic tie resolution?”)
40 action block
42 action block
44 system
46 process step
48 process step
50 process step
52 process step
54 eviction ranking
56 voting result
58 eviction ranking
60 voting result
60′ result
62 eviction ranking
64 eviction ranking
66 voting result
68 eviction ranking
70 eviction ranking
72 voting result
74 eviction ranking
76 eviction ranking
78 voting result
80 eviction ranking
82 eviction ranking
84 voting result
A memory block
B memory block
C memory block
D memory block
E memory block

1. A memory manager, the memory manager being configured to:
determine a plurality of eviction rankings, wherein each of the plurality of eviction rankings ranks a plurality of eviction candidates based on at least one eviction criterion;
select one of said eviction candidates by applying a voting algorithm to the plurality of eviction rankings; and
cause the selected eviction candidate to be evicted.

2. The memory manager of claim 1, wherein, by ranking, each of the plurality of eviction rankings assigns a position within the eviction ranking to each of the plurality of eviction candidates.

3. The memory manager of claim 1, wherein the voting algorithm determines the most favored eviction candidates across multiple eviction rankings by aggregating measures of favorability derived from the multiple eviction rankings.

4. The memory manager of claim 1, the memory manager being further configured to:
determine the plurality of eviction rankings in parallel.

5. The memory manager of claim 1, the memory manager being further configured to:
reapply the voting algorithm to a subset of the plurality of eviction rankings if a tie occurs between candidates, most favored for eviction by the voting algorithm; or
apply another voting algorithm to the plurality of eviction rankings if a tie occurs between candidates that are most favored for eviction by the previously applied voting algorithm.

6. The memory manager of claim 5, the memory manager being further configured to:
randomly select one of the eviction candidates between which a tie has occurred, if reapplying the voting algorithm or applying the other voting algorithm does not favor one of the candidates previously most favored for eviction by the voting algorithm.

7. The memory manager of claim 1, wherein the eviction candidates are memory blocks.

8. A method of managing a memory, comprising:
determining a first eviction ranking which ranks a plurality of eviction candidates based on at least one first eviction criterion;
determining a second eviction ranking which ranks the plurality of eviction candidates based on at least one second eviction criterion;
determining a first eviction candidate based on the first eviction ranking and the second eviction ranking, by applying a voting algorithm to the first and second eviction rankings; and
evicting the first eviction candidate.

9. The method of claim 8, wherein evicting the first eviction candidate involves replacing first data stored in the first eviction candidate with second data.

10. The method of claim 8, wherein the eviction candidates are memory blocks.

11. The method of managing a memory according to claim 10,
wherein the first and second eviction rankings assign to each block of the memory a position in the first eviction ranking and the second eviction ranking, respectively.

12. The method of managing a memory according to claim 11,
wherein a memory block to which a lowest position in the first eviction ranking and/or a lowest position in the second eviction ranking is assigned, is excluded from being determined as the first memory block.

13. The method of managing a memory according to claim 10,
wherein determining the first memory block for eviction based on the first eviction ranking and the second eviction ranking comprises assigning a third value to the first memory block;
wherein the third value is an output of a function which takes a first value assigned to a first position of the first memory block in the first eviction ranking and a second value assigned to a second position of the first memory block in the second eviction ranking as inputs.

14. The method of managing a memory according to claim 13,
wherein the third value is used to establish a voting result and the first memory block is a memory block to which is assigned a highest position in the voting result.

15. The method of managing a memory according to claim 13,
wherein determining the first memory block for eviction based on the first eviction ranking and the second eviction ranking further comprises assigning a sixth value to a second memory block;
wherein the sixth value is an output of the function which takes a fourth value assigned to a fourth position of the second memory block in the first eviction ranking and a fifth value assigned to a fifth position of the second memory block in the second eviction ranking as inputs;
wherein, if the sixth value equals the third value, one of the first and second eviction rankings is disregarded for determining the first memory block for eviction.

16. The method of managing a memory according to claim 13,
wherein the third value is a linear combination of the first value and the second value.

17. The method of managing a memory according to claim 13, further comprising:
monitoring the eviction decisions for favoritism and adapting the function if favoritism is detected.

18. The method of managing a memory according to claim 10, further comprising:
determining a third eviction ranking which ranks the plurality of memory blocks based on at least one third eviction criterion;
determining a preliminary voting result based on the first eviction ranking, the second eviction ranking and the third eviction ranking; and
detecting a tie regarding the first memory block and a second memory block, based on the preliminary voting result.

19. The method of managing a memory according to claim 10, further comprising:
determining a fourth eviction ranking which ranks the plurality of memory blocks based on the at least one first eviction criterion;
determining a fifth eviction ranking which ranks the plurality of memory blocks based on the at least one second eviction criterion;
selecting a third memory block for eviction based on the fourth eviction ranking and the fifth eviction ranking; and
replacing third data stored in the third memory block with fourth data.

20. The method of managing a memory according to claim 10,
wherein the memory is a cache;
and the method further comprises:
detecting a cache miss in regard to the second data; and
determining that the cache is full.
